(19) United States
(12) Patent Application Publication
(10) Pub. No.: US 2012/0215538 A1
(43) Pub. Date: Aug. 23, 2012

(54) Performance measurement for customer contact centers

(75) Inventors: Andrew Cleasby, Haverhill, MA (US); Robert Zacher, Arlington, MA (US)

(73) Assignee: CISCO TECHNOLOGY, INC., San Jose, CA (US)

(21) Appl. No.: 12/932,102

(22) Filed: Feb. 17, 2011

(51) Int. Cl. G10L 15/04; H04M 3/00

(52) U.S. Cl. 704/251; 379/266.1; 704/E15.005

(57) ABSTRACT

In one embodiment, a method includes identifying a first communication from a customer, identifying a second communication from the customer following a response to the first communication from a contact center, and analyzing the first and second communications at a contact center network device to determine a change in sentiment from the first communication to the second communication. An apparatus for contact center performance measurement is also disclosed.

### TECHNICAL FIELD

The present disclosure relates generally to customer contact centers, and more specifically, to performance measurement for customer contact centers.

### BACKGROUND

Customer contact centers provide customer care by responding to customers and providing assistance or information. Traditionally, customers would call a contact center to report a problem or request information. The manner in which customers prefer to interact with companies is changing and businesses are challenged with providing customer care in the manner in which customers want to communicate. Conventional agent performance measurements are often based on response time. Traditional contact center agent performance measurement using response time metrics may not be appropriate for all customer center operations.

### BRIEF DESCRIPTION OF THE FIGURES

FIG. 1 illustrates an example of a network in which embodiments described herein may be implemented.

FIG. 2 depicts an example of data collection for use in recording sentiment data for customer care performance measurement.

FIG. 3 is a flowchart illustrating a process for customer care performance measurement, in accordance with one embodiment.

Corresponding reference characters indicate corresponding parts throughout the several views of the drawings.

### DESCRIPTION OF EXAMPLE EMBODIMENTS

### Overview

In one embodiment, a method generally comprises identifying a first communication from a customer, identifying a second communication from the customer following a response to said first communication from a contact center, and analyzing the first and second communications at a contact center network device to determine a change in sentiment from the first communication to the second communication.

In another embodiment, an apparatus generally comprises a processor for identifying a first communication from a customer, identifying a second communication from the customer following a response to said first communication from a contact center, and analyzing the first and second communications to determine a change in sentiment from the first communication to the second communication. The apparatus further includes memory for storing the change in sentiment.

### Example Embodiments

The following description is presented to enable one of ordinary skill in the art to make and use the embodiments. Descriptions of specific embodiments and applications are provided only as examples, and various modifications will be readily apparent to those skilled in the art. The general principles described herein may be applied to other applications without departing from the scope of the embodiments. Thus, the embodiments are not to be limited to those shown, but are to be accorded the widest scope consistent with the principles and features described herein. For purpose of clarity, details relating to technical material that is known in the technical fields related to the embodiments have not been described in detail.

Consumers are engaging in an ever increasing number of online conversations and interactions. Social network services are often used by consumers to communicate and in some cases talk about the companies that they do business with. For example, a consumer may describe a particular problem in detail, including the brand or model of a product or a service provided. A customer contact center that has the ability to monitor and respond to customer conversations available from social network services can provide more efficient customer service. This proactive response can benefit companies in many ways. Also, the social media networks are full of potential customers asking for advice about a product or service. The contact center may offer advice and product information to assist in decision making, therefore creating brand recognition, and possibly expanding their customer base.

As companies devote contact center agents to social media monitoring and response, the need to measure and manage agent performance for these activities becomes important. Agent performance management can improve agent efficiency and effectiveness and ultimately brand perception value.

Traditional contact center agent performance measurement using response time metrics may not be appropriate for social media. In the social media context, response time may be less important than the quality of response. Higher quality responses may result in higher customer satisfaction. Analyzing and measuring the quality or effectiveness of an agent's response is therefore useful in managing agent performance in the social media environment.

The embodiments described herein utilize sentiment data collected for communications related to agent interactions with a customer to measure agent performance including, for example, the effectiveness of agent responses. The communications may be, for example, postings on a social media web site, e-mail or text messages, audio or video communications, or any other type of communication.

As described in detail below, sentiment data is collected for a first communication and compared to sentiment data for a second communication that takes place after an agent has responded to the first communication. The comparison may be used to determine agent or campaign effectiveness by measuring the impact of an agent's response on customer sentiment.

The term ‘sentiment’ as used herein refers to a satisfaction level or other indicator of a customer's attitude, view, thoughts, or opinion that can be quantitatively measured, as described below. The term ‘customer’ as used herein refers to a contact such as a current customer or potential customer associated with a communication in which sentiment is measured.

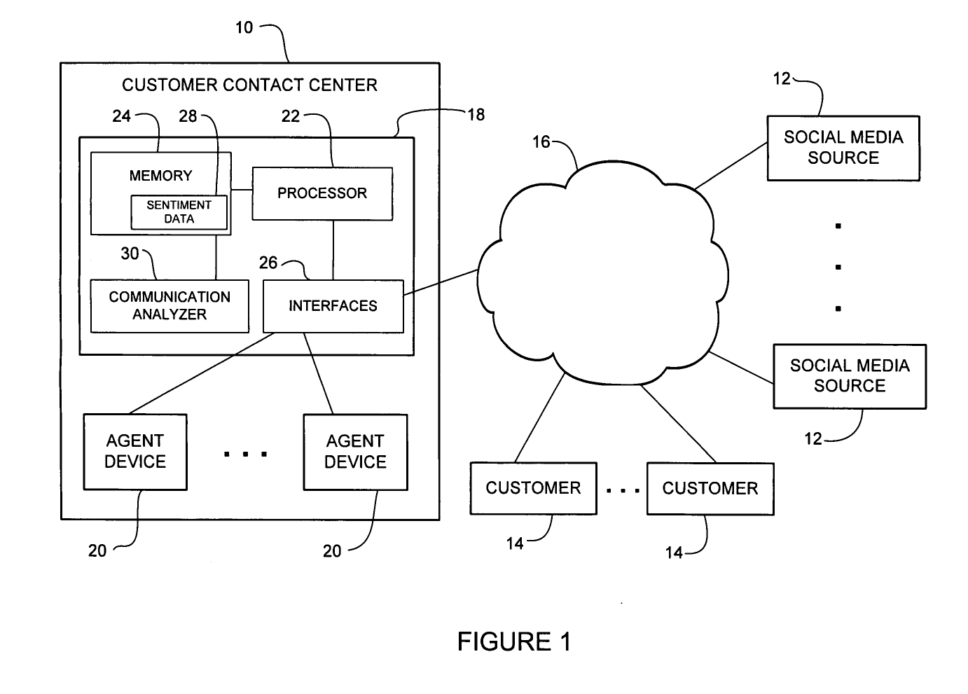

Referring now to the figures, and first to FIG. 1, a network in which the embodiments described herein may be implemented is shown. A customer contact center 10 is in communication with one or more social media sources 12 and one or more customers 14 via a network 16. The network 16 may include, for example, a local area network (LAN), wireless LAN (WLAN), wide area network (WAN), cellular network, Internet, intranet, mobile data network, public switched telephone network (PSTN), and the like, or any combination thereof. The customers 14 may communicate with the customer contact center via the social media source 12 or communicate directly using, for example, a computer, mobile device, telephone, or any other communication device.

The social media source 12 may comprise a social media host that provides social network services, public forum, blog site, or other source that provides user postings or a feed (e.g., RSS (Really Simple Syndication)). The social media source 12 may be a profile based social network in which users create a profile that represents the user (e.g., Facebook, MySpace, LinkedIn). Another example of a social media source is a blog (Blogger, Wordpress, Blogspot) or microblog (e.g., Google Buzz, Facebook status update, Twitter). Other examples of social media sources 12 include community forums, location based social network services, business oriented social network services, etc. It is to be understood that these are only examples and other social media sources may be used without departing from the scope of the embodiments.

The customer contact center 10 may monitor and respond to customer conversations originating in the social media source 12 or communicate directly with the customer 14 using, for example, e-mail, instant message, text message, short message service (SMS), telephone communications, or any other communication means. The customer contact center 10 includes one or more contact center network devices 18 in communication with one or more agent devices 20.

The agent device 20 may comprise a telephone (e.g., IP phone, landline phone, mobile phone), a computer (e.g., personal computer, mobile computing device), or any other communication device or combination of communication devices that allow an agent to communicate with the customers 14 either directly or via the social media source 12.

The network device 18 at the customer contact center 10 may comprise one or more network devices (e.g., servers) configured for receiving, processing, and storing customer data. The embodiments described herein may be implemented, for example, at a virtual machine on the network device 18. The network device 18 may also comprise remotely located devices (e.g., storage) or the network device 18 may be located remote from the customer contact center or agents.

In one embodiment, the network device 18 is a programmable machine that may be implemented in hardware, software, or any combination thereof. The network device 18 includes one or more processors 22, memory 24, and one or more network interfaces 26. Memory 24 may be a volatile memory or non-volatile storage, which stores various applications, operating systems, modules, and data for execution and use by the processor 22. Data such as sentiment data 28 for use in agent performance measurement may also be stored in memory 24 using one or more data structures (e.g., relational database). As described below, the network device 18 also includes a communication analyzer 30 for use in analyzing the communications and generating the sentiment data 28.

Logic may be encoded in one or more tangible media for execution by the processor 22. For example, the processor 22 may execute codes stored in a computer-readable medium such as memory 24. The computer-readable medium may be, for example, electronic (e.g., RAM (random access memory), ROM (read-only memory), EPROM (erasable programmable read-only memory)), magnetic, optical (e.g., CD, DVD), electromagnetic, semiconductor technology, or any other suitable medium.

The network interface 26 may comprise one or more wireless or wired interfaces (linecards, ports) for receiving signals or data or transmitting signals or data to other devices. The interfaces 26 may include, for example, an Ethernet interface for connection to a computer or network.

It is to be understood that the network device 18 shown in FIG. 1 and described above is only one example and that different configurations of network devices may be used.

The customer contact center 10 may monitor one or more of the social media sources 12 to identify relevant communications from current or potential customers. The contact center 10 may filter the social media postings according to a product identifier (e.g., brand name, model number), service identifier, or any other identifier or keyword associated with a particular product or service. The customer contact center 10 may monitor the social media sources 12 periodically (e.g., once a day). The monitoring may also be limited to a list of known customers or by specific geographic regions. The customer contact center 10 may also access social media postings based on a trigger (e.g., when a request directly from a customer 14 is received at the contact center 10).

The social media postings may be public or private. Public postings may be accessed through knowledge of the customer's name or URL. The customer may disclose the location of public postings through a questionnaire e-mail, a prompt from a telephone communication system, a warranty card, or by the request of a customer contact center agent. Public postings may also be located by using a search engine with the customer's name or other identification. Private postings may only be accessed with the customer's permission. The customer contact center 10 may send an electronic request, such as a friend request, to the customer. The request may be sent in response to the customer disclosing that the customer uses social networking services, for example. Postings captured by the contact center 10 may be grouped into user defined campaigns, for example.

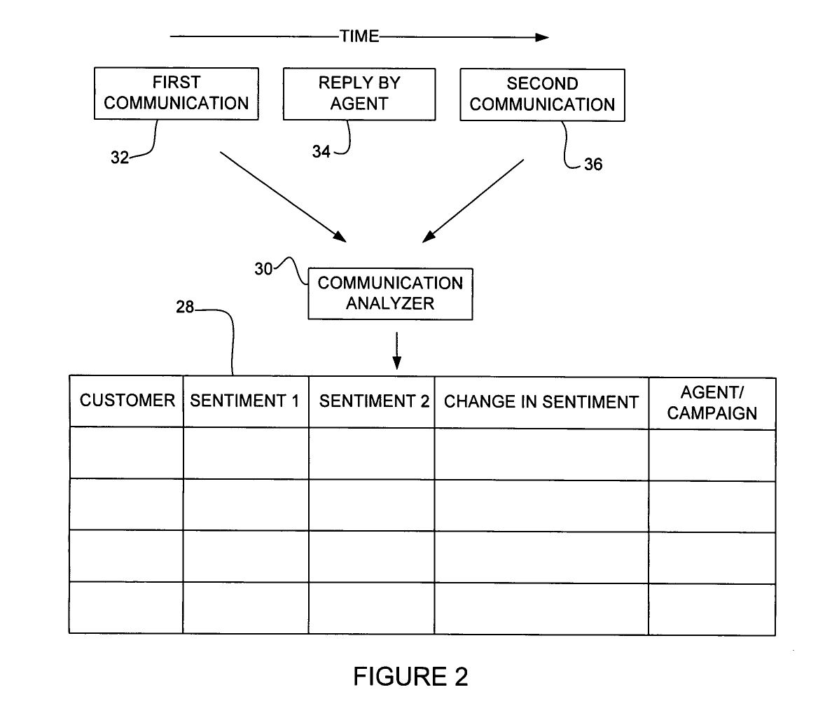

FIG. 2 illustrates an example of data collection for use in recording sentiment data for customer care performance measurement, in accordance with one embodiment. A first communication (e.g., posting, e-mail, text, call, etc.) 32 from a customer is identified. The communication may be identified, for example, by the contact center 10 monitoring the social media sources 12 or incoming communications from customers 14. After the first communication 32 is identified, it is presented to one of the contact center agents for response. Agents respond to the identified communications as part of their normal workflow. The agent's response 34 may be a direct communication to the customer (e.g., e-mail, phone call, etc.) or the agent may post a response to a social media stream. The contact center 10 monitors posts from agents or any replies by agents to the first communication 32. The agent's response 34 is preferably identified in the database so that the first communication is associated with the agent (or campaign).

The contact center 10 identifies a second communication 36 associated with the first communication 32 (e.g., related to the same product or service, originated by same customer) and generated following the response 34 to the first communication from the contact center. The second communication 36 includes social media activity or other communications generated based on the response 34 to the first communication 32. For example, a social media user may repeat the agent response due to its helpfulness (or lack thereof), or respond directly back to the agent. The first and second communications 32, 36 may be the same type of communication (e.g., social media post, e-mail, telephone call) or may be different types of communications (e.g., one communication is a posting at social media source 12 and the other communication is a direct communication between the contact center 10 and customer 14).

In addition to monitoring communications received from the same customer after the agent responds to the customer's communication, the contact center may also monitor and analyze communications originated from different customers and associated with the first communication or response.

The communication analyzer 30 analyzes the first and second communications 32, 36 and records sentiment data in table 28. The sentiment data for the second communication 36 is compared to the sentiment data for the first communication 32 to determine a change in the customer's sentiment and therefore measure the impact of the agent's response 34 to the customer. The first communication 32 may be collected by the contact center and analyzed for sentiment at the time it is identified or may be stored and later analyzed with the second communication 36.

The sentiment data may be stored in a data structure such as the table 28 shown in FIG. 2. In this example, the table 28 includes the customer, measurement of sentiment for the first communication 32 (sentiment 1), measurement of sentiment for the second communication 36 (sentiment 2), and a change in sentiment (e.g., relative change in measurement of sentiment or identification of general direction of change (e.g., worse, same, better)). The change in sentiment data may be positive or negative. The data may be associated with an agent (e.g., agent posting or transmitting response 34), a team of agents, or a campaign. It is to be understood that the table shown in FIG. 2 is only an example and that the data may be recorded in other data structures without departing from the scope of the embodiments.

The difference between the original sentiment and the follow on sentiment reflects the quality of the agent's response. An improvement in sentiment reflects a higher quality agent response than a decline in sentiment. Agents working within the same campaign will have varying degrees of effectiveness based on their skill and knowledge. Agents with lower effectiveness may be coached or reassigned, thus improving the overall effectiveness of the agent pool over time.

The customer originating the communication is preferably identified by the customer contact center 10. If the communication is a telephone call, caller identification (ID) or an interactive voice response system may be used to identify the customer 14. If the communication is from a social media source or direct electronic communication, the customer may be identified by an e-mail address, URL (uniform resource locator), or username, for example.

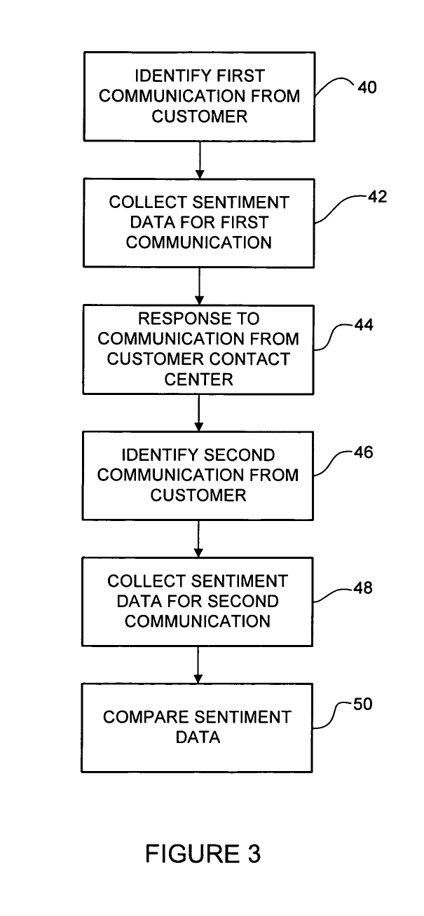

FIG. 3 is a flowchart illustrating a process for performance measurement at the customer contact center 10, in accordance with one embodiment. At step 40 a first communication from a customer is identified. The customer may be a current customer or a potential customer. The communication may be a direct communication from the customer 14 or a social media communication (e.g., posting at one of the social media sources 12). The first communication is analyzed and a measurement of the customer's sentiment for the communication is recorded (step 42). The agent responds to the communication at step 44. The agent may, for example, send an e-mail, call the customer, or reply to the customer's social media post. As responses are seen by the customer and possibly shared with others, the response may generate additional social media activity (e.g., social media posts) or direct communication between the customer 14 and contact center 10 (e.g., e-mail or call to contact center). The customer contact center 10 identifies one or more follow on communications associated with the first communication (step 46). These follow on communications are collected and also analyzed for sentiment (step 48). The sentiment data collected for the first and second communications are compared to determine a change in the customer's sentiment (step 50).

It is to be understood that the process shown in FIG. 3 and described above is only an example and that steps may be added, reordered, or combined, without departing from the scope of the embodiments.

The experience of the customer may be used to assess the performance of the agent. Data relating to performances may be collected for a particular agent, a group of agents, or agents responding to communications associated with a particular product or campaign.

The sentiment changes across a group of responses from an agent and within a campaign may be collected and statistically analyzed to provide metrics about change in sentiment achieved by each agent and campaign. Collecting statistics from sentiment analysis such as mean sentiment change and sentiment change standard deviation allows contact center supervisors to compare agents and campaigns for effectiveness and consistency. Larger data sets will provide more reliable results. The statistical analysis can provide confidence estimates on the sentiment measurements.

Sentiment may be measured using one or more dimensions (e.g., urgency, anger, etc.). Multiple dimensions are preferably used for a more accurate understanding of the customer's sentiment. Monitoring of the communication to collect sentiment data may include monitoring vocabulary used in the communication, phrases used in the interaction, or emotion associated with the interaction. Monitoring the emotion may involve determining if a caller sounds satisfied or unsatisfied, or if the caller and the contact center agent are participating in a video conference, determining if the facial expression of the caller indicates whether the caller is satisfied or unsatisfied. Vocabulary may be monitored to determine if it indicates satisfaction and portrays positive emotion. A text analytics module may be used to detect or sniff for keywords or phrases that indicate a level of satisfaction. The measurement may be based on occurrence (or number of occurrences) of specified keywords. For example, the text analytics module may identify words such as satisfied, unsatisfied, helpful, unhelpful, answered, unanswered, good, bad, like, dislike, happy, unhappy, etc.

It is to be understood that the data measurements described herein are only examples and that other measurements may be used to identify a customer's sentiment of the communication.

Although the method and apparatus have been described in accordance with the embodiments shown, one of ordinary skill in the art will readily recognize that there could be variations made without departing from the scope of the embodiments. Accordingly, it is intended that all matter contained in the above description and shown in the accompanying drawings shall be interpreted as illustrative and not in a limiting sense.

What is claimed is:

1. A method comprising:
identifying a first communication from a customer;
identifying a second communication from the customer following a response to said first communication from a contact center; and
analyzing said first and second communications at a contact center network device to determine a change in sentiment from said first communication to said second communication.

2. The method of claim 1 wherein at least one of said first and second communications comprises a social media communication.

3. The method of claim 1 further comprising recording a measurement of the customer's sentiment in said first communication and recording a measurement of the customer's sentiment in said second communication, and wherein determining said change in sentiment comprises comparing said measurements of the customer's sentiment for said first and second communications.

4. The method of claim 3 wherein said measurements are based on occurrences of keywords in said communications.

5. The method of claim 1 further comprising associating said change in sentiment with an agent from the contact center responding to said first communication.

6. The method of claim 1 wherein identifying one of said first and second communications comprises monitoring a social media source for specified keywords.

7. The method of claim 1 wherein identifying said first communication comprises identifying the customer originating said first communication.

8. The method of claim 1 wherein analyzing said first and second communications comprises searching for text within said communications.

9. The method of claim 1 further comprising collecting sentiment data for all communications for which an agent from the contact center provided a response.

10. An apparatus comprising:
a processor for identifying a first communication from a customer, identifying a second communication from the customer following a response to said first communication from a contact center, and analyzing said first and second communications to determine a change in sentiment from said first communication to said second communication; and
memory for storing said change in sentiment.

11. The apparatus of claim 10 wherein at least one of said first and second communications comprises a social media communication.

12. The apparatus of claim 10 wherein the memory is further configured for storing a measurement of the customer's sentiment in said first communication and a measurement of the customer's sentiment in said second communication and wherein determining said change in sentiment comprises comparing said measurements of the customer's sentiment for said first and second communications.

13. The apparatus of claim 10 wherein said change in sentiment is associated with an agent from the contact center responding to said first communication.

14. The apparatus of claim 10 wherein identifying one of said first and second communications comprises monitoring a social media source for specified keywords.

15. The apparatus of claim 10 wherein identifying said first communication comprises identifying the customer originating said first communication.

16. The apparatus of claim 10 wherein analyzing said first and second communications comprises searching for text within said communications.

17. Logic encoded on one or more tangible computer readable media for execution and when executed operable to:
identify a first communication from a customer;
identify a second communication from the customer following a response to said first communication from a contact center; and
analyze said first and second communications to determine a change in sentiment from said first communication to said second communication.

18. The logic of claim 17 wherein at least one of said first and second communications comprises a social media communication.

19. The apparatus of claim 17 wherein said change in sentiment is associated with an agent from the contact center responding to said first communication.

20. The apparatus of claim 17 further comprising logic operable to search for text within said communications.
